(19) United States
(12) Patent Application Publication
(10) Pub. No.: US 2021/0027300 A1
(43) Pub. Date: Jan. 28, 2021

(54) System, Method, and Computer Program Product for Generating Aggregations Associated with Predictions of Transactions

(71) Applicant: Visa International Service Association, San Francisco, CA (US)

(72) Inventors: Chiranjeet Chetia, Round Rock, TX (US); Shubham Agrawal, Round Rock, TX (US); Claudia Carolina Barcenas Cardenas, Austin, TX (US)

(21) Appl. No.: 16/522,907

(22) Filed: Jul. 26, 2019

(51) Int. Cl. G06Q 20/40; G06Q 30/02; G06N 20/00; G06N 5/04

(52) U.S. Cl. CPC G06Q 20/4016; G06N 5/046; G06N 20/00; G06Q 30/0224

(57) ABSTRACT

Provided is a system that includes at least one processor programmed or configured to: determine an average payment transaction vector based on a first payment transaction vector associated with a first payment transaction involving an account and a second payment transaction vector associated with a second payment transaction involving the account; determine an account embedding vector associated with the account based on the first payment transaction vector associated with the first payment transaction and the second payment transaction vector associated with the second payment transaction; determine a predicted transaction aggregate vector associated with the account based on the account embedding vector and a plurality of embedding payment transaction vectors associated with a plurality of payment transactions; and store the predicted transaction aggregate vector in a data structure based on an account identifier of the account. A computer-implemented method and computer program product are also provided.

### BACKGROUND

### 1. Field

This disclosure relates generally to machine learning models and, in some non-limiting aspects or embodiments, to systems, methods, and computer program products for generating aggregations associated with predictions of transactions for use with a machine learning model.

### 2. Technical Considerations

Machine learning may be a field of computer science that uses statistical techniques to provide a computer system with the ability to learn (e.g., to progressively improve performance of) a task with data without the computer system being explicitly programmed to perform the task. In some instances, a machine learning model may be developed for a set of data so that the machine learning model may perform a task (e.g., a task associated with a prediction) with regard to the set of data.

In some instances, a machine learning model, such as a predictive machine learning model, may be used to make a prediction regarding a risk or an opportunity based on data. A predictive machine learning model may be used to analyze a relationship between the performance of a unit based on data associated with the unit and one or more known features of the unit. The objective of the predictive machine learning model may be to assess the likelihood that a similar unit will exhibit the performance of the unit. A predictive machine learning model may be used as a fraud detection model. For example, predictive machine learning models may perform calculations based on data associated with payment transactions to evaluate the risk or opportunity of a payment transaction involving a customer, in order to guide a decision of whether to authorize the payment transaction.

In some examples, a predictive machine learning model may require an input that includes features that are based on an aggregation of data. For example, the predictive machine learning model requires an input that includes features that are based on an aggregation of data that is calculated in real-time. However, calculating the aggregation of data in real-time may be very resource intensive and may require a large amount of time to calculate.

### SUMMARY

Accordingly, disclosed are systems, methods, and computer program products for generating an aggregation associated with a prediction of payment transactions for use with a machine learning model.

According to some non-limiting aspects or embodiments, provided is a computer-implemented method, comprising: receiving, with at least one processor, payment transaction data associated with a plurality of payment transactions involving an account; determining, with at least one processor, an average payment transaction vector associated with an average of a first payment transaction vector associated with a first payment transaction involving the account and a second payment transaction vector associated with a second payment transaction involving the account; determining, with at least one processor, an account embedding vector associated with the account; determining, with at least one processor, a predicted transaction aggregate vector associated with the account based on the account embedding vector and a plurality of embedding payment transaction vectors associated with a plurality of payment transactions, wherein determining the predicted transaction aggregate vector comprises: providing the account embedding vector and a first embedding payment transaction vector associated with a first payment transaction as an input to a first gated recurrent unit (GRU), providing an output of the first GRU to a second GRU and a second embedding payment transaction vector associated with a second payment transaction, wherein the output of the first GRU comprises a first set of weights, and obtaining an output from the second GRU comprising the predicted transaction aggregate vector associated with the account; and storing, with at least one processor, the predicted transaction aggregate vector associated with the predicted payment transaction in a data structure based on an account identifier of the account.

According to some non-limiting aspects or embodiments, provided is a system, including at least one processor programmed or configured to: determine an average payment transaction vector based on a first payment transaction vector associated with a first payment transaction involving an account and a second payment transaction vector associated with a second payment transaction involving the account; determine an account embedding vector associated with the account based on the first payment transaction vector associated with the first payment transaction and the second payment transaction vector associated with the second payment transaction; determine a predicted transaction aggregate vector associated with the account based on the account embedding vector and a plurality of embedding payment transaction vectors associated with a plurality of payment transactions; and store the predicted transaction aggregate vector in a data structure based on an account identifier of the account.

According to some non-limiting aspects or embodiments, provided is a computer program product comprising at least one non-transitory computer-readable medium comprising one or more instructions that, when executed by at least one processor, cause the at least one processor to: receive payment transaction data associated with a plurality of payment transactions; determine an average of a first payment transaction vector associated with a first payment transaction and a second payment transaction vector associated with a second payment transaction based on the payment transaction data associated with the plurality of payment transactions; determine an account embedding vector associated with an account based on the average of the first payment transaction vector associated with the first payment transaction and the second payment transaction vector associated with the second payment transaction; determine a predicted transaction aggregate vector associated with the account based on the account embedding vector a plurality of embedding payment transaction vectors associated with a plurality of payment transactions, wherein, when determining the predicted transaction aggregate vector, the one or more instructions that, when executed by the at least one processor, cause the at least one processor to: provide the account embedding vector and a first embedding payment transaction vector associated with a first payment transaction as an input to a first gated recurrent unit (GRU), provide a plurality of weight values from the first GRU, the account embedding vector, and a second embedding payment transaction vector associated with a first payment transaction as an input to a second GRU; and obtain an output from the second GRU, wherein the output comprises the predicted transaction aggregate vector; and store the predicted transaction aggregate vector in a data structure based on an account identifier of the account.

Further non-limiting aspects or embodiments are set forth in the following numbered clauses:

Clause 1: A computer-implemented method, comprising: receiving, with at least one processor, payment transaction data associated with a plurality of payment transactions involving an account; determining, with at least one processor, an average payment transaction vector associated with an average of a first payment transaction vector associated with a first payment transaction involving the account and a second payment transaction vector associated with a second payment transaction involving the account; determining, with at least one processor, an account embedding vector associated with the account; determining, with at least one processor, a predicted transaction aggregate vector associated with the account based on the account embedding vector and a plurality of embedding payment transaction vectors associated with a plurality of payment transactions, wherein determining the predicted transaction aggregate vector comprises: providing the account embedding vector and a first embedding payment transaction vector associated with a first payment transaction as an input to a first gated recurrent unit (GRU), providing an output of the first GRU to a second GRU and a second embedding payment transaction vector associated with a second payment transaction, wherein the output of the first GRU comprises a first set of weights, and obtaining an output from the second GRU comprising the predicted transaction aggregate vector associated with the account; and storing, with at least one processor, the predicted transaction aggregate vector associated with the predicted payment transaction in a data structure based on an account identifier of the account.

Clause 2: The method of clause 1, further comprising: receiving first payment transaction data associated with a first payment transaction involving the account, the first payment transaction being conducted in real-time; determining whether the first payment transaction satisfies a risk assessment threshold based on the first payment transaction data associated with the first payment transaction involving the account; and determining whether a predicted transaction aggregate vector associated with the account is stored in the data structure.

Clause 3: The method of clauses 1 or 2, further comprising: retrieving the predicted transaction aggregate vector associated with the account based on determining that the predicted transaction aggregate vector associated with the account is stored in the data structure.

Clause 4: The method of any of clauses 1-3, further comprising: determining a risk assessment score for the first payment transaction based on the predicted transaction aggregate vector associated with the account and the first payment transaction data associated with the first payment transaction involving the account; and performing an action based on determining that the risk assessment score satisfies a threshold.

Clause 5: The method of any of clauses 1-4, further comprising: generating the predicted transaction aggregate vector associated with the account based on determining that the predicted transaction aggregate vector associated with the account is not stored in the data structure.

Clause 6: The method of any of clauses 1-5, wherein the first payment transaction vector associated with the first payment transaction comprises a plurality of values, the plurality of values associated with a merchant category group of the first payment transaction, a transaction amount of the first payment transaction, and a merchant location of a merchant involved in the first payment transaction, wherein the second payment transaction vector associated with the second payment transaction comprises a plurality of values, the plurality of values associated with a merchant category group of the second payment transaction, a transaction amount of the second payment transaction, and a merchant location of a merchant involved in the second payment transaction; and wherein determining the average of the first payment transaction vector associated with the first payment transaction and the second payment transaction vector associated with the second payment transaction comprises: determining an average of the plurality of values associated with the merchant category group of the first payment transaction, the transaction amount of the first payment transaction, the merchant location of the merchant involved in the first payment transaction and the plurality of values associated with the merchant category group of the second payment transaction, the transaction amount of the second payment transaction, the merchant location of a merchant involved in the second payment transaction to generate an average transaction vector.

Clause 7: The method of any of clauses 1-6, wherein determining the account embedding vector associated with the account comprises: concatenating the average transaction vector and an initial account embedding vector to generate a concatenated embedding payment transaction vector associated with the account; and providing the concatenated embedding payment transaction vector as an input to a neural network.

Clause 8: The method of any of clauses 1-7, wherein determining the account embedding vector associated with the account comprises: determining a plurality of values of the account embedding vector associated with the account such that an output of the neural network is equal to a third payment transaction vector associated with a third payment transaction involving the account.

Clause 9: A system, comprising: at least one processor programmed or configured to: determine an average payment transaction vector based on a first payment transaction vector associated with a first payment transaction involving an account and a second payment transaction vector associated with a second payment transaction involving the account; determine an account embedding vector associated with the account based on the first payment transaction vector associated with the first payment transaction and the second payment transaction vector associated with the second payment transaction; determine a predicted transaction aggregate vector associated with the account based on the account embedding vector and a plurality of embedding payment transaction vectors associated with a plurality of payment transactions; and store the predicted transaction aggregate vector in a data structure based on an account identifier of the account.

Clause 10: The system of clause 9, wherein, when determining the predicted transaction aggregate vector, the at least one processor is programmed or configured to: provide the account embedding vector and a first embedding payment transaction vector associated with a first payment transaction as an input to a first gated recurrent unit (GRU); and provide a plurality of weight values from the first GRU, the account embedding vector, and a second embedding payment transaction vector associated with a second payment transaction as an input to a second GRU; wherein an output of the second GRU comprises the predicted transaction aggregate vector.

Clause 11: The system of clauses 9 or 10, wherein the at least one processor is further programmed or configured to: receive first payment transaction data associated with a first payment transaction involving the account, the first payment transaction being conducted in real-time; determine whether a predicted transaction aggregate vector associated with the account is stored in the data structure.

Clause 12: The system of any of clauses 9-11, wherein the at least one processor is further programmed or configured to: retrieve the predicted transaction aggregate vector associated with the account based on determining that the predicted transaction aggregate vector associated with the account is stored in the data structure.

Clause 13: The system of any of clauses 9-12, wherein the at least one processor is further programmed or configured to: determine a risk assessment score for the first payment transaction based on the predicted transaction aggregate vector associated with the account and the first payment transaction data associated with the first payment transaction involving the account; determining whether the risk assessment score for the first payment transaction satisfies a risk assessment threshold; and perform an action based on determining that the risk assessment score for the first payment transaction satisfies a risk assessment threshold.

Clause 14: The system of any of clauses 9-13, wherein the at least one processor is further programmed or configured to: generate the predicted transaction aggregate vector associated with the account based on determining that the predicted transaction aggregate vector associated with the account is not stored in the data structure.

Clause 15: A computer program product comprising at least one non-transitory computer-readable medium comprising one or more instructions that, when executed by at least one processor, cause the at least one processor to: receive payment transaction data associated with a plurality of payment transactions; determine an average of a first payment transaction vector associated with a first payment transaction and a second payment transaction vector associated with a second payment transaction based on the payment transaction data associated with the plurality of payment transactions; determine an account embedding vector associated with an account based on the average of the first payment transaction vector associated with the first payment transaction and the second payment transaction vector associated with the second payment transaction; determine a predicted transaction aggregate vector associated with the account based on the account embedding vector a plurality of embedding payment transaction vectors associated with a plurality of payment transactions, wherein, when determining the predicted transaction aggregate vector, the one or more instructions that, when executed by the at least one processor, cause the at least one processor to: provide the account embedding vector and a first embedding payment transaction vector associated with a first payment transaction as an input to a first gated recurrent unit (GRU), provide a plurality of weight values from the first GRU, the account embedding vector, and a second embedding payment transaction vector associated with a first payment transaction as an input to a second GRU; and obtain an output from the second GRU, wherein the output comprises the predicted transaction aggregate vector; and store the predicted transaction aggregate vector in a data structure based on an account identifier of the account.

Clause 16: The computer program product of clause 15, wherein the first payment transaction vector associated with the first payment transaction comprises a plurality of vector values associated with a merchant category group of the first payment transaction, a transaction amount of the first payment transaction, and a merchant location of a merchant involved in the first payment transaction and wherein the second payment transaction vector associated with the second payment transaction comprises a plurality of vector values associated with a merchant category group of the second payment transaction, a transaction amount of the second payment transaction, and a merchant location of a merchant involved in the second payment transaction; and wherein the one or more instructions that cause the at least one processor to determine the average of the first payment transaction vector associated with the first payment transaction and the second payment transaction vector associated with the second payment transaction cause the at least one processor to: determine an average of the plurality of vector values associated with the merchant category group of the first payment transaction, the transaction amount of the first payment transaction, the merchant location of the merchant involved in the first payment transaction and the plurality of vector values associated with the merchant category group of the second payment transaction, the transaction amount of the second payment transaction, the merchant location of a merchant involved in the second payment transaction to generate an average transaction vector.

Clause 17: The computer program product of clauses 15 or 16, wherein the one or more instructions that cause the at least one processor to determine the account embedding vector associated with the account cause the at least one processor to: concatenate the average transaction vector and the account embedding vector associated with the account to generate a concatenated embedding payment transaction vector; and provide the concatenated embedding payment transaction vector as an input to a neural network.

Clause 18: The computer program product of any of clauses 15-17, wherein the one or more instructions that cause the at least one processor to determine the account embedding vector associated with the account cause the at least one processor to: determine a plurality of vector values of the account embedding vector associated with the account such that an output of the neural network is equal to a third vector associated with a third payment transaction involving the account.

Clause 19: The computer program product of any of clauses 15-18, wherein the one or more instructions further cause the at least one processor to: receive first payment transaction data associated with a first payment transaction involving the account, the first payment transaction being conducted in real-time; determine whether the payment transaction satisfies a risk assessment threshold based on the payment transaction data associated with the payment transaction involving the account; and determine whether a predicted transaction aggregate vector associated with the account is stored in the data structure.

Clause 20: The computer program product of any of clauses 15-19, wherein the one or more instructions further cause the at least one processor to: retrieve the predicted transaction aggregate vector associated with the account based on determining that the predicted transaction aggregate vector associated with the account is stored in the data structure.

These and other features and characteristics of the present disclosure, as well as the methods of operation and functions of the related elements of structures and the combination of parts and economies of manufacture, will become more apparent upon consideration of the following description and the appended claims with reference to the accompanying drawings, all of which form a part of this specification, wherein like reference numerals designate corresponding parts in the various figures. It is to be expressly understood, however, that the drawings are for the purpose of illustration and description only and are not intended as a definition of the limits of the present disclosure. As used in the specification and the claims, the singular form of “a,” “an,” and “the” include plural referents unless the context clearly dictates otherwise.

### BRIEF DESCRIPTION OF THE DRAWINGS

Additional advantages and details of non-limiting embodiments or aspects are explained in greater detail below with reference to the exemplary embodiments that are illustrated in the accompanying schematic figures, in which:

FIG. 1 is a diagram of a non-limiting aspect or embodiment of a system for generating a predicted transaction aggregate vector to compare to a payment transaction;

FIG. 2 is a diagram of a non-limiting aspect or embodiment of components of one or more devices and/or one or more systems of FIG. 1;

FIG. 3 is a flowchart of a non-limiting aspect or embodiment of a process for generating an aggregation associated with a prediction of payment transactions for use with a machine learning model;

FIGS. 4A-4C are diagrams of a non-limiting embodiment of an implementation of a process for determining an account embedding vector; and

FIGS. 5A-5D are diagrams of a non-limiting embodiment of an implementation of a process for determining predicted transaction aggregate vectors.

### DESCRIPTION

For purposes of the description hereinafter, the terms “end,” “upper,” “lower,” “right,” “left,” “vertical,” “horizontal,” “top,” “bottom,” “lateral,” “longitudinal,” and derivatives thereof shall relate to the disclosure as it is oriented in the drawing figures. However, it is to be understood that the disclosure may assume various alternative variations and step sequences, except where expressly specified to the contrary. It is also to be understood that the specific devices and processes illustrated in the attached drawings, and described in the following specification, are simply exemplary embodiments or aspects of the disclosure. Hence, specific dimensions and other physical characteristics related to the embodiments or aspects of the embodiments disclosed herein are not to be considered as limiting unless otherwise indicated.

No aspect, component, element, structure, act, step, function, instruction, and/or the like used herein should be construed as critical or essential unless explicitly described as such. Also, as used herein, the articles “a” and “an” are intended to include one or more items, and may be used interchangeably with “one or more” and “at least one.” Furthermore, as used herein, the term “set” is intended to include one or more items (e.g., related items, unrelated items, a combination of related and unrelated items, and/or the like) and may be used interchangeably with “one or more” or “at least one.” Where only one item is intended, the term “one” or similar language is used. Also, as used herein, the terms “has,” “have,” “having,” or the like are intended to be open-ended terms. Further, the phrase “based on” is intended to mean “based at least partially on” unless explicitly stated otherwise.

As used herein, the terms “communication” and “communicate” may refer to the reception, receipt, transmission, transfer, provision, and/or the like of information (e.g., data, signals, messages, instructions, commands, and/or the like). For one unit (e.g., a device, a system, a component of a device or system, combinations thereof, and/or the like) to be in communication with another unit means that the one unit is able to directly or indirectly receive information from and/or send (e.g., transmit) information to the other unit. This may refer to a direct or indirect connection that is wired and/or wireless in nature. Additionally, two units may be in communication with each other even though the information transmitted may be modified, processed, relayed, and/or routed between the first and second unit. For example, a first unit may be in communication with a second unit even though the first unit passively receives information and does not actively send information to the second unit. As another example, a first unit may be in communication with a second unit if at least one intermediary unit (e.g., a third unit located between the first unit and the second unit) processes information received from the first unit and sends the processed information to the second unit. In some non-limiting embodiments, a message may refer to a network packet (e.g., a data packet and/or the like) that includes data.

As used herein, the terms “issuer,” “issuer institution,” “issuer bank,” or “payment device issuer,” may refer to one or more entities that provide accounts to individuals (e.g., users, customers, and/or the like) for conducting payment transactions such as such as credit payment transactions and/or debit payment transactions. For example, an issuer institution may provide an account identifier, such as a primary account number (PAN), to a customer that uniquely identifies one or more accounts associated with that customer. In some non-limiting embodiments, an issuer may be associated with a bank identification number (BIN) that uniquely identifies the issuer institution. As used herein, the term “issuer system” may refer to one or more computer systems operated by or on behalf of an issuer, such as a server executing one or more software applications. For example, an issuer system may include one or more authorization servers for authorizing a transaction.

As used herein, the term “account identifier” may include one or more types of identifiers associated with an account (e.g., a PAN associated with an account, a card number associated with an account, a payment card number associated with an account, a token associated with an account, and/or the like). In some non-limiting embodiments, an issuer may provide an account identifier (e.g., a PAN, a token, and/or the like) to a user (e.g., an account holder) that uniquely identifies one or more accounts associated with that user. The account identifier may be embodied on a payment device (e.g., a physical instrument used for conducting payment transactions, such as a payment card, a credit card, a debit card, a gift card, and/or the like) and/or may be electronic information communicated to the user that the user may use for electronic payment transactions. In some non-limiting embodiments, the account identifier may be an original account identifier, where the original account identifier was provided to a user at the creation of the account associated with the account identifier. In some non-limiting embodiments, the account identifier may be a supplemental account identifier, which may include an account identifier that is provided to a user after the original account identifier was provided to the user. For example, if the original account identifier is forgotten, stolen, and/or the like, a supplemental account identifier may be provided to the user. In some non-limiting embodiments, an account identifier may be directly or indirectly associated with an issuer institution such that an account identifier may be a token that maps to a PAN or other type of account identifier. Account identifiers may be alphanumeric, any combination of characters and/or symbols, and/or the like.

As used herein, the term “token” may refer to an account identifier of an account that is used as a substitute or replacement for another account identifier, such as a PAN. Tokens may be associated with a PAN or other original account identifier in one or more data structures (e.g., one or more databases) such that they may be used to conduct a payment transaction without directly using an original account identifier. In some non-limiting embodiments, an original account identifier, such as a PAN, may be associated with a plurality of tokens for different individuals or purposes. In some non-limiting embodiments, tokens may be associated with a PAN or other account identifiers in one or more data structures such that they can be used to conduct a transaction without directly using the PAN or the other account identifiers. In some examples, an account identifier, such as a PAN, may be associated with a plurality of tokens for different uses or different purposes.

As used herein, the term “merchant” may refer to one or more entities (e.g., operators of retail businesses) that provide goods, services, and/or access to goods and/or services, to a user (e.g., a customer, a consumer, and/or the like) based on a transaction such as a payment transaction. As used herein, the term “merchant system” may refer to one or more computer systems operated by or on behalf of a merchant, such as a server executing one or more software applications. As used herein, the term “product” may refer to one or more goods and/or services offered by a merchant.

As used herein, the term “point-of-sale (POS) device” may refer to one or more electronic devices, which may be used by a merchant to conduct a transaction (e.g., a payment transaction) and/or process a transaction. Additionally or alternatively, a POS device may include peripheral devices, card readers, scanning devices (e.g., code scanners and/or the like), Bluetooth® communication receivers, near-field communication (NFC) receivers, radio frequency identification (RFID) receivers, and/or other contactless transceivers or receivers, contact-based receivers, payment terminals, and/or the like.

As used herein, the term “POS system” may refer to one or more client devices and/or peripheral devices used by a merchant to conduct a transaction. For example, a POS system may include one or more POS devices and/or other like devices that may be used to conduct a payment transaction. In some non-limiting embodiments, a POS system (e.g., a merchant POS system) may include one or more server computers programmed or configured to process online payment transactions through webpages, mobile applications, and/or the like.

As used herein, the term “transaction service provider” may refer to an entity that receives transaction authorization requests from merchants or other entities and provides guarantees of payment, in some cases through an agreement between the transaction service provider and an issuer institution. In some non-limiting embodiments, a transaction service provider may include a credit card company, a debit card company, a payment network such as Visa®, MasterCard®, AmericanExpress®, or any other entity that processes transaction. As used herein, the term “transaction service provider system” may refer to one or more computer systems operated by or on behalf of a transaction service provider, such as a transaction service provider system executing one or more software applications. A transaction service provider system may include one or more processors and, in some non-limiting embodiments, may be operated by or on behalf of a transaction service provider.

As used herein, the term “payment device” may refer to a payment card (e.g., a credit or debit card), a gift card, a smart card (e.g., a chip card, an integrated circuit card, and/or the like), smart media, a payroll card, a healthcare card, a wristband, a machine-readable medium containing account information, a keychain device or fob, an RFID transponder, a retailer discount or loyalty card, and/or the like. The payment device may include a volatile or a non-volatile memory to store information (e.g., an account identifier, a name of the account holder, and/or the like).

As used herein, the term “computing device” may refer to one or more electronic devices that are configured to directly or indirectly communicate with or over one or more networks. In some non-limiting embodiments, a computing device may include a mobile device. A mobile device may include a smartphone, a portable computer, a wearable device (e.g., watches, glasses, lenses, clothing, and/or the like), a personal digital assistant (PDA), and/or other like devices. In some non-limiting embodiments, a computing device may include a server, a desktop computer, and/or the like.

As used herein, the terms “client” and “client device” may refer to one or more computing devices, such as processors, storage devices, and/or similar computer components, that access a service made available by a server. In some non-limiting embodiments, a “client device” may refer to one or more devices that facilitate payment transactions, such as one or more POS devices used by a merchant. In some non-limiting embodiments, a client device may include a computing device configured to communicate with one or more networks and/or facilitate payment transactions such as, but not limited to, one or more desktop computers, one or more mobile devices, and/or other like devices. Moreover, a “client” may also refer to an entity, such as a merchant, that owns, utilizes, and/or operates a client device for facilitating payment transactions with a transaction service provider.

As used herein, the term “server” may refer to one or more computing devices, such as processors, storage devices, and/or similar computer components that communicate with client devices and/or other computing devices over a network, such as the Internet or private networks and, in some examples, facilitate communication among other servers and/or clients.

As used herein, the term “system” may refer to one or more computing devices or combinations of computing devices such as, but not limited to, processors, servers, client devices, software applications, and/or other like components. In addition, reference to “a server” or “a processor,” as used herein, may refer to a previously-recited server and/or processor that is recited as performing a previous step or function, a different server and/or processor, and/or a combination of servers and/or processors. For example, as used in the specification and the claims, a first server and/or a first processor that is recited as performing a first step or function may refer to the same or different server and/or a processor recited as performing a second step or function.

In some non-limiting embodiments, computer-implemented methods, systems, and computer program products are disclosed. For example, a computer-implemented method may include receiving payment transaction data associated with a plurality of payment transactions involving an account, determining an average payment transaction vector associated with an average of a first payment transaction vector associated with a first payment transaction involving the account and a second payment transaction vector associated with a second payment transaction involving the account, determining an account embedding vector associated with the account, determining a predicted transaction aggregate vector associated with the account based on the account embedding vector and a plurality of embedding payment transaction vectors associated with a plurality of payment transactions, and storing, with at least one processor, the predicted transaction aggregate vector associated with the predicted payment transaction in a data structure based on an account identifier of the account. In some non-limiting embodiments, determining the predicted transaction aggregate vector comprises providing the account embedding vector and a first embedding payment transaction vector associated with a first payment transaction as an input to a first gated recurrent unit (GRU), providing an output of the first GRU to a second GRU and a second embedding payment transaction vector associated with a second payment transaction, wherein the output of the first GRU comprises a first set of weights, and obtaining an output from the second GRU comprising the predicted transaction aggregate vector associated with the account.

In this way, non-limiting embodiments of the present disclosure allow for avoiding calculating data associated with aggregation, such as a predicted transaction aggregate vector associated with an account, in real-time (e.g., in real-time during a payment transaction), which may reduce the amount of computer resources involved with conducting a payment transaction (e.g., conducting a fraud detection determination, determining whether an offer associated with an account involved in a payment transaction is available, and/or the like) and may reduce the amount of time necessary to calculate the predicted transaction aggregate vector. Further, the use of gated recurrent units (GRUs) when determining the predicted transaction aggregate vector associated with the account may provide a more accurate determination of the predicted transaction aggregate vector as compared to determining the predicted transaction aggregate vector based on other machine learning techniques since the use of GRUs allows for the use of an account embedding vector associated with the account and that is specific to the account (e.g., based on transaction data associated with payment transactions conducted involving the account) to be included in determining the predicted transaction aggregate vector.

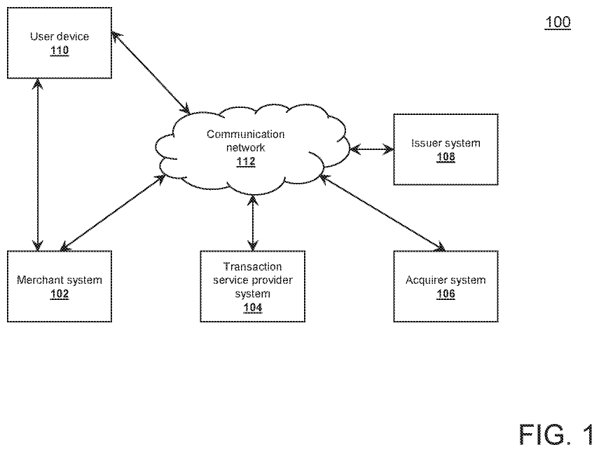

Referring now to FIG. 1, FIG. 1 is a diagram of an example environment 100 in which devices, systems, methods, and/or products described herein may be implemented. As shown in FIG. 1, environment 100 includes merchant system 102, transaction service provider system 104, acquirer system 106, issuer system 108, and user device 110. Merchant system 102, transaction service provider system 104, acquirer system 106, issuer system 108, and user device 110 may interconnect (e.g., establish a connection to communicate, and/or the like) via wired connections, wireless connections, or a combination of wired and wireless connections.

Merchant system 102 may include one or more devices capable of being in communication with transaction service provider system 104, acquirer system 106, issuer system 108, and user device 110 via communication network 112. For example, merchant system 102 may include one or more payment devices, one or more computing devices, such as one or more mobile devices, one or more smartphones, one or more wearable devices (e.g., watches, glasses, lenses, clothing, and/or the like), one or more personal digital assistants (PDAs), one or more servers, and/or the like. In some non-limiting embodiments, merchant system 102 may communicate via a short-range wireless communication connection (e.g., a wireless communication connection for communicating information in a range between 2 to 3 centimeters to 5 to 6 meters, such as a near-field communication (NFC) communication connection, a radio frequency identification (RFID) communication connection, a Bluetooth® communication connection, and/or the like). In some non-limiting embodiments, merchant system 102 may be associated with a merchant, as described herein.

Transaction service provider system 104 may include one or more devices capable of being in communication with merchant system 102, acquirer system 106, issuer system 108 and/or user device 110 via communication network 112. For example, transaction service provider system 104 may include a server (e.g., a transaction processing server), a group of servers (e.g., a group of transaction processing servers), and/or other like devices. In some non-limiting embodiments, transaction service provider system 104 may be associated with a transaction service provider as described herein.

Acquirer system 106 may include one or more devices capable of being in communication with merchant system 102, transaction service provider system 104, issuer system 108, and/or user device 110 via communication network 112. For example, acquirer system 106 may include one or more computing devices, such one or more servers and/or other like devices. In some non-limiting embodiments, acquirer system 106 may be associated with an acquirer as described herein.

Issuer system 108 may include one or more devices capable of being in communication with merchant system 102, transaction service provider system 104, acquirer system 106, and/or user device 110 via communication network 112. For example, issuer system 108 may include may include one or more computing devices, such one or more servers and/or other like devices. In some non-limiting embodiments, issuer system 108 may be associated with an issuer institution that issued a payment account and/or instrument (e.g., a credit account, a debit account, a credit card, a debit card, and/or the like) to a user.

User device 110 may include one or more devices capable of being in communication with merchant system 102, transaction service provider system 104, acquirer system 106, and/or issuer system 108 via communication network 112. For example, user device 110 may include one or more computing devices, such as one or more mobile devices, one or more smartphones, one or more wearable devices, one or more servers, and/or the like. In some non-limiting embodiments, user device 110 may communicate via a short-range wireless communication connection. In some non-limiting embodiments, user device 110 may be associated with a user as described herein.

Communication network 112 may include one or more wired and/or wireless networks. For example, communication network 112 may include a cellular network (e.g., a long-term evolution (LTE) network, a third generation (3G) network, a fourth generation (4G) network, a code division multiple access (CDMA) network, and/or the like), a public land mobile network (PLMN), a local area network (LAN), a wide area network (WAN), a metropolitan area network (MAN), a telephone network (e.g., the public switched telephone network (PSTN)), a private network, an ad hoc network, an intranet, the Internet, a fiber optic-based network, a cloud computing network, and/or the like, and/or a combination of some or all of these or other types of networks.

The number and arrangement of systems and/or devices shown in FIG. 1 are provided as an example. There may be additional systems and/or devices, fewer systems and/or devices, different systems and/or devices, or differently arranged systems and/or devices than those shown in FIG. 1. Furthermore, two or more systems and/or devices shown in FIG. 1 may be implemented within a single system or a single device, or a single system or a single device shown in FIG. 1 may be implemented as multiple, distributed systems or devices. Additionally, or alternatively, a set of systems or a set of devices (e.g., one or more systems, one or more devices) of environment 100 may perform one or more functions described as being performed by another set of systems or another set of devices of environment 100.

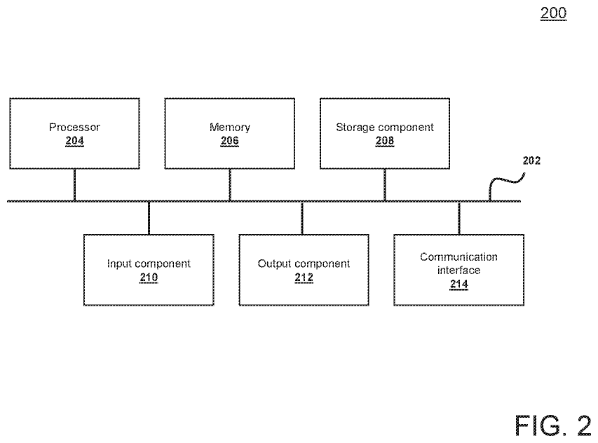

Referring now to FIG. 2, illustrated is a diagram of example components of device 200. Device 200 may correspond to one or more devices of transaction service provider system 104, one or more devices of merchant system 102 (e.g., one or more devices of a device of merchant system 102), one or more devices of acquirer system 106, one or more devices of issuer system 108, and/or one or more devices of user device 110. In some non-limiting aspects or embodiments, one or more devices of transaction service provider system 104, one or more devices of merchant system 102, one or more devices of acquirer system 106, one or more devices of issuer system 108, and/or one or more devices of user device 110 may include at least one device 200 and/or at least one component of device 200. As shown in FIG. 2, device 200 may include bus 202, processor 204, memory 206, storage component 208, input component 210, output component 212, and communication interface 214.

Bus 202 may include a component that permits communication among the components of device 200. In some non-limiting aspects or embodiments, processor 204 may be implemented in hardware, firmware, or a combination of hardware and software. For example, processor 204 may include a processor (e.g., a central processing unit (CPU), a graphics processing unit (GPU), an accelerated processing unit (APU), and/or the like), a microprocessor, a digital signal processor (DSP), and/or any processing component (e.g., a field-programmable gate array (FPGA), an application-specific integrated circuit (ASIC), and/or the like) that can be programmed to perform a function. Memory 206 may include random access memory (RAM), read-only memory (ROM), and/or another type of dynamic or static storage device (e.g., flash memory, magnetic memory, optical memory, and/or the like) that stores information and/or instructions for use by processor 204.

Storage component 208 may store information and/or software related to the operation and use of device 200. For example, storage component 208 may include a hard disk (e.g., a magnetic disk, an optical disk, a magneto-optic disk, a solid state disk, and/or the like), a compact disc (CD), a digital versatile disc (DVD), a floppy disk, a cartridge, a magnetic tape, and/or another type of computer-readable medium, along with a corresponding drive.

Input component 210 may include a component that permits device 200 to receive information, such as via user input (e.g., a touchscreen display, a keyboard, a keypad, a mouse, a button, a switch, a microphone, a camera, and/or the like). Additionally or alternatively, input component 210 may include a sensor for sensing information (e.g., a global positioning system (GPS) component, an accelerometer, a gyroscope, an actuator, and/or the like). Output component 212 may include a component that provides output information from device 200 (e.g., a display, a speaker, one or more light-emitting diodes (LEDs), and/or the like).

Communication interface 214 may include a transceiver-like component (e.g., a transceiver, a separate receiver and transmitter, and/or the like) that enables device 200 to communicate with other devices, such as via a wired connection, a wireless connection, or a combination of wired and wireless connections. Communication interface 214 may permit device 200 to receive information from another device and/or provide information to another device. For example, communication interface 214 may include an Ethernet interface, an optical interface, a coaxial interface, an infrared interface, a radio frequency (RF) interface, a universal serial bus (USB) interface, a WiFi® interface, a cellular network interface, and/or the like.

Device 200 may perform one or more processes described herein. Device 200 may perform these processes based on processor 204 executing software instructions stored by a computer-readable medium, such as memory 206 and/or storage component 208. A computer-readable medium (e.g., a non-transitory computer-readable medium) is defined herein as a non-transitory memory device. A memory device includes memory space located inside of a single physical storage device or memory space spread across multiple physical storage devices.

Software instructions may be read into memory 206 and/or storage component 208 from another computer-readable medium or from another device via communication interface 214. When executed, software instructions stored in memory 206 and/or storage component 208 may cause processor 204 to perform one or more processes described herein. Additionally or alternatively, hardwired circuitry may be used in place of or in combination with software instructions to perform one or more processes described herein. Thus, embodiments or aspects described herein are not limited to any specific combination of hardware circuitry and software.

Memory 206 and/or storage component 208 may include data storage or one or more data structures (e.g., a database, and/or the like). Device 200 may be capable of retrieving information from, storing information in, or searching information stored in the data storage or one or more data structures in memory 206 and/or storage component 208. For example, the information may include encryption data, input data, output data, transaction data, account data, or any combination thereof.

The number and arrangement of components shown in FIG. 2 are provided as an example. In some non-limiting aspects or embodiments, device 200 may include additional components, fewer components, different components, or differently arranged components than those shown in FIG. 2. Additionally or alternatively, a set of components (e.g., one or more components) of device 200 may perform one or more functions described as being performed by another set of components of device 200.

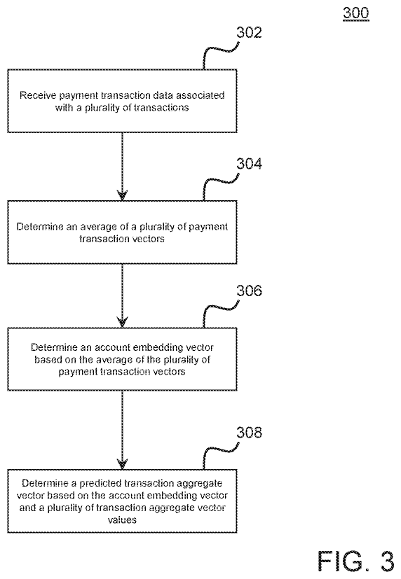

Referring now to FIG. 3, illustrated is a flowchart of a non-limiting embodiment of a process 300 for generating an aggregation associated with a prediction of payment transactions for use with a machine learning model. In some non-limiting aspects or embodiments, one or more of the functions described with respect to process 300 may be performed (e.g., completely, partially, and/or the like) by transaction service provider system 104. In some non-limiting embodiments, one or more of the steps of process 300 may be performed (e.g., completely, partially, and/or the like) by another device or a group of devices separate from and/or including transaction service provider system 104 such as, for example, merchant system 102, acquirer system 106, issuer system 108, and/or user device 110.

As shown in FIG. 3, at step 302, process 300 may include receiving payment transaction data associated with a plurality of payment transactions. For example, transaction service provider system 104 may receive payment transaction data associated with a plurality of payment transactions involving an account (e.g., a debit account, a credit account, a debit card account, a credit card account, and/or the like) of a user (e.g., a user associated with user device 110). In some non-limiting embodiments, transaction service provider system 104 may receive the transaction data from merchant system 102, acquirer system 106, issuer system 108, and/or user device 110 (e.g., via network 112). For example, transaction service provider system 104 may receive the transaction data from merchant system 102 via network 112 in real-time while a payment transaction is being conducted, after a payment transaction has been authorized, after a payment transaction has been cleared, and/or after a payment transaction has been settled. Transaction service provider system 104 may receive transaction data (e.g., historical transaction data, first transaction data, first historical transaction data, and/or the like) associated with a plurality of payment transactions involving (e.g., conducted by) a user, a plurality of users, and/or the like. In some non-limiting embodiments, the payment transaction data may be associated with a plurality of payment transactions involving one or more accounts of a user, a plurality of accounts of a plurality of users, and/or the like. In some non-limiting embodiments, the payment transaction data may include historical payment transaction data associated with one or more payment transactions that have been authorized, cleared, and/or settled.

In some non-limiting embodiments, transaction service provider system 104 may receive transaction data associated with a plurality of payment transactions conducted during a time interval (e.g., a plurality of payment transactions conducted within an hour, a plurality of payment transactions conducted within a day, a plurality of payment transactions conducted within a week, and/or the like) involving an account of a user. For example, transaction service provider system 104 may receive the transaction data associated with the plurality of payment transactions conducted during a predetermined time interval involving the account of the user.

In some non-limiting embodiments, the payment transaction data may be associated with a payment transaction (e.g., a payment transaction of a plurality of payment transactions) and/or a plurality of payment transactions. For example, the transaction data may be associated with a payment transaction involving a user and a merchant (e.g., a merchant associated with merchant system 102). In some non-limiting embodiments, the plurality of payment transactions may involve a plurality of users and a plurality of merchants and each payment transaction of the plurality of payment transactions may involve a single user and a single merchant.

In some non-limiting embodiments, the transaction data associated with a payment transaction may include transaction amount data associated with an amount of the payment transaction (e.g., a cost associated with the payment transaction, a transaction amount, an overall transaction amount, a cost of one or more products involved in the payment transaction, and/or the like), transaction time data associated with a time interval at which the payment transaction occurred (e.g., a time of day, a day of the week, a day of a month, a month of a year, a predetermined time of day segment such as morning, afternoon, evening, night, and/or the like, a predetermined day of the week segment such as weekday, weekend, and/or the like, a predetermined segment of a year such as first quarter, second quarter, and/or the like), transaction type data associated with a transaction type of the payment transaction (e.g., an online transaction, a card present transaction, a face-to-face transaction, and/or the like), and/or the like.

Additionally or alternatively, the transaction data may include user transaction data associated with the user involved in the payment transaction, merchant transaction data associated with the merchant involved in the payment transaction, and/or issuer institution transaction data associated with an issuer institution of an account involved in the payment transaction. In some embodiments, user transaction data may include user identity data associated with an identity of the user (e.g., a unique identifier of the user, a name of the user, and/or the like), user account data associated with an account of the user (e.g., an account identifier associated with the user, a PAN associated with a credit and/or debit account of the user, a token associated with a credit and/or debit account of the user, and/or the like), and/or the like.

In some embodiments, merchant transaction data may include merchant identity data associated with an identity of the merchant (e.g., a unique identifier of the merchant, a name of the merchant, and/or the like), merchant category data associated with at least one merchant category of the merchant (e.g., a code for a merchant category, a name of a merchant category, a type of a merchant category, and/or the like), merchant account data associated with an account of the merchant (e.g., an account identifier associated with an account of the merchant, a PAN associated with an account of the merchant, a token associated with an account of the merchant, and/or the like), and/or the like.

In some embodiments, issuer institution transaction data may include issuer institution identity data associated with the issuer institution that issued an account involved in the payment transaction (e.g., a unique identifier of the issuer institution, a name of the issuer institution, an issuer identification number (IIN) associated with the issuer institution, a BIN associated with the issuer institution, and/or the like), and/or the like.

In some non-limiting embodiments, transaction data associated with a payment transaction (e.g., each payment transaction of a plurality of payment transactions) may identify a merchant category of a merchant involved in the payment transaction. For example, transaction data associated with the payment transaction may include merchant transaction data that identifies a merchant category of a merchant involved in the payment transaction. A merchant category may be information that is used to classify the merchant based on the type of goods or services the merchant provides. In some non-limiting embodiments, a payment transaction may involve a merchant that is associated with a merchant category of a plurality of merchant categories.

In some non-limiting embodiments, transaction data associated with a payment transaction may identify a time (e.g., a time of day, a day, a week, a month, a year, and/or the like) at which the payment transaction occurred. For example, the transaction data associated with the payment transaction may include transaction time data that identifies a time interval at which the payment transaction occurred.

As shown in FIG. 3, at step 304, process 300 may include determining an average of a plurality of payment transaction vectors. For example, transaction service provider system 104 may determine the average of the plurality of payment transaction vectors based on the payment transaction data.

In some non-limiting embodiments, a payment transaction vector associated with a payment transaction may include an array of values associated with parameters (e.g., a time interval, an amount, a transaction type, and/or the like) of the payment transaction. For example, a first payment transaction vector, a second payment transaction vector, and a third payment transaction vector may each include one or more arrays of values that include parameters of the first payment transaction, the second payment transaction, and the third payment transaction, respectively. In such an example, a position at which a value is located (e.g., stored) in an array of a payment transaction vector may be associated with a parameter of a payment transaction (e.g., the value included at a first position of a payment transaction vector may be a value associated with a merchant identifier for the payment transaction, the value included at a second position of a payment transaction vector may be a value associated with a date and/or time interval of a payment transaction, the value included at a third position of a payment transaction vector may be a value associated with a transaction amount of a payment transaction, the value included at a fourth position of a payment transaction vector may be a value associated with a channel such as, a payment channel (e.g., a physical POS system channel, a mobile payment channel, an online checkout channel or a retail channel (e.g., an e-commerce channel, a brick and mortar channel, and/or the like), and/or the like).

In some non-limiting embodiments, the average of the plurality of payment transaction vectors may include an average payment transaction vector. The average payment transaction vector may include one or more arrays of values that include parameters of the average of parameters of the plurality of payment transactions.

In some non-limiting embodiments, transaction service provider system 104 may determine the average of a first payment transaction vector associated with a first payment transaction of the plurality of payment transaction vectors and a second payment transaction vector associated with a second payment transaction of the plurality of payment transaction vectors. For example, transaction service provider system 104 may determine an average transaction vector associated with an average (e.g., a mean) of the first payment transaction vector associated with the first payment transaction and the second payment transaction vector associated with the second payment transaction. The average transaction vector may include an array of values that are based on an average of the values of the first payment transaction vector and the values of the second payment transaction vector.

In some non-limiting embodiments, transaction service provider system 104 may determine the average transaction vector associated with an average of the first payment transaction vector associated with the first payment transaction and the second payment transaction vector by calculating a sum of the values associated with each of the first payment transaction vector and the second payment transaction vector associated with each given position. In such an example, transaction service provider system 104 may determine that the value associated with the first position of the average transaction vector is equal to the sum of the value associated with the first position of the first payment transaction vector and the value associated with the first position of the second payment transaction vector. Transaction service provider system 104 may repeat this process to determine a value associated with each position of the average transaction vector based on the values associated with respective positions of the first payment transaction vector and the second payment transaction vector. Transaction service provider system 104 may then divide the value associated with each position of the average transaction vector by the amount of vectors associated with payment transactions being averaged. For example, transaction service provider system 104 may divide the sum of the values associated with each of the first payment transaction vector and the second payment transaction vector associated with each position of the first payment transaction vector and the second payment transaction vector by two, thereby determining an average of the values associated with each position of the average transaction vector.

In some non-limiting embodiments, transaction service provider system 104 may determine an average transaction vector periodically, continuously, or based on receiving transaction data associated with a transaction. For example, transaction service provider system 104 may determine an average transaction vector after or in response to receiving transaction data associated with one or more payment transactions. In another example, transaction service provider system 104 may determine the average transaction vector based on determining that a payment transaction satisfies a risk assessment threshold.

As shown in FIG. 3, at step 306, process 300 may include determining an account embedding vector associated with the account. For example, transaction service provider system 104 may determine the account embedding vector associated with the account based on the average vector associated with the average of the first payment transaction vector associated with the first payment transaction and the second payment transaction vector associated with the second payment transaction and an account embedding vector associated with the account (e.g., an initial account embedding vector associated with the account, a modified account embedding vector associated with the account, and/or the like). In an example, transaction service provider system 104 may determine the account embedding vector associated with the account based on receiving instant transaction data associated with an instant payment transaction (e.g., a transaction received at a point in time after the plurality of transactions associated with the transaction data were processed and/or received by the transaction service provider system 104). In such an example, transaction service provider system 104 may determine the account embedding vector associated with the account based on determining that the instant payment transaction satisfies a risk assessment threshold. In such an example, transaction service provider system 104 may compare a value of one or more parameters associated with one or more payment transactions from among the plurality of payment transactions associated with the payment transaction data to a value of a parameter of the instant payment transaction associated with instant payment transaction data. Transaction service provider system 104 may then determine, based on the comparison, that the instant payment transaction satisfies the risk assessment threshold. Where transaction service provider system 104 determines that the instant payment transaction satisfies the risk assessment threshold, transaction service provider system 104 may determine the account embedding vector associated with the account. Where transaction service provider system 104 determines that the instant payment transaction does not satisfy the risk assessment threshold, transaction service provider system 104 may forego determining the account embedding vector associated with the account.

In some non-limiting embodiments, transaction service provider system 104 may determine the account embedding vector associated with the account based on determining that a predicted transaction aggregate vector associated with a predicted payment transaction is not stored in a data structure. In such an example, transaction service provider system 104 may determine that the predicted transaction aggregate vector associated with the predicted payment transaction that would be used to determine a risk assessment score is not stored in the data structure. In this example, transaction service provider system 104 may then determine the account embedding vector associated with the account.

In some non-limiting embodiments, determining the account embedding vector associated with the account may include concatenating an initial account embedding vector (e.g., a vector that was initialized including predetermined and/or random values stored at each position of the vector) to an average transaction vector associated with an average of a first payment transaction vector associated with a first payment transaction and a second payment transaction vector associated with a second payment transaction. For example, transaction service provider system 104 may concatenate the initial account embedding vector associated with the initial account embedding to the average transaction vector associated with the average of a first payment transaction vector associated with a first payment transaction and a second payment transaction vector associated with a second payment transaction to generate a concatenated payment transaction vector associated with the account. In some non-limiting embodiments, transaction service provider system 104 may then provide the concatenated payment transaction vector associated with the account as input to a neural network to generate a predicted payment transaction vector associated with a predicted payment transaction as an output from the neural network. In such an example, transaction service provider system 104 may compare the predicted payment transaction vector associated with the predicted payment transaction to a third payment transaction vector associated with a third payment transaction (e.g., a payment transaction that occurs after the first payment transaction and the second payment transaction, a payment transaction that occurs in sequence after the first payment transaction and the second payment transaction, and/or the like) and transaction service provider system 104 may determine a modified account embedding vector associated with the account based on the neural network. For example, transaction service provider system 104 may determine the modified account embedding vector associated with the account based on data obtained from a hidden layer of the neural network after providing the concatenated payment transaction vector associated with the account as input to the neural network.

In some non-limiting embodiments, transaction service provider system 104 may concatenate the average payment transaction vector and the modified account embedding vector to generate a second concatenated payment transaction vector. In such an example, transaction service provider system 104 may then provide the second concatenated payment transaction vector as input to the neural network to generate a predicted payment transaction vector associated with a predicted payment transaction as an output from the neural network. In such an example, transaction service provider system 104 may compare the predicted payment transaction vector associated with the predicted payment transaction to a fourth payment transaction vector associated with a fourth payment transaction (e.g., a payment transaction that occurs after the third payment transaction, a payment transaction that occurs in sequence after the third payment transaction, and/or the like) and transaction service provider system 104 may determine a final account embedding vector associated with the account based on the neural network. For example, transaction service provider system 104 may determine the final account embedding vector associated with the account based on data obtained from the hidden layer of the neural network after providing the second concatenated payment transaction vector associated with the account as input to the neural network.

As shown in FIG. 3, at step 308, process 300 may include determining a predicted transaction aggregate vector associated with a predicted future payment transaction. For example, transaction service provider system 104 may determine a predicted transaction aggregate vector associated with a predicted payment transaction. In some non-limiting embodiments, transaction service provider system 104 may determine the predicted transaction aggregate vector associated with the predicted future payment transaction before receiving instant transaction data associated with an instant payment transaction. In another example, transaction service provider system 104 may determine the predicted transaction aggregate vector associated with the predicted future payment transaction based on receiving instant transaction data associated with an instant transaction. In yet another example, transaction service provider system 104 may determine the predicted transaction aggregate vector associated with the predicted payment transaction based on determining that an instant transaction satisfies a risk assessment threshold (e.g., a risk assessment threshold for a machine learning model).

In some non-limiting embodiments, transaction service provider system 104 may determine the predicted transaction aggregate vector associated with the predicted future payment transaction based on an account embedding vector associated with an account and a plurality of embedding payment transaction vectors associated with a plurality of payment transactions. For example, transaction service provider system 104 may provide the account embedding vector and a first embedding payment transaction vector associated with a first payment transaction selected from among the plurality of embedding payment transaction vectors as an input to a first gated recurrent unit (GRU). In such an example, transaction service provider system 104 may then obtain, as outputs from the first GRU, GRU weight data associated with a first set of weights associated with the first GRU and a first predicted transaction aggregate vector associated with a first predicted payment transaction. Transaction service provider system 104 may then provide the GRU weight data associated with the first set of weights associated with the first GRU and a second embedding payment transaction vector associated with a second payment transaction selected from among the plurality of embedding payment transaction vectors as input to a second GRU. In some non-limiting embodiments, transaction service provider system 104 may obtain, as an output from the second GRU, a second predicted transaction aggregate vector associated with a second predicted payment transaction. In some non-limiting embodiments, each of the plurality of payment transaction vectors associated with the plurality of payment transactions may include an array of values associated with parameters (e.g., a time interval, an amount, a transaction type, and/or the like) of the plurality of payment transactions.

In some non-limiting embodiments, transaction service provider system 104 may determine an amount of error between the first predicted transaction aggregate vector associated with the first predicted payment transaction and the second embedding payment transaction vector associated with the second payment transaction. In some non-limiting embodiments, GRU error data associated with a deviation between the first predicted payment transaction and the second payment transaction associated with the second embedding payment transaction vector may be determined. For example, transaction service provider system 104 may determine the GRU error data associated with the deviation between the first predicted payment transaction and the second payment transaction. In such an example, transaction service provider system 104 may determine GRU weight data associated with a first set of weights associated with the first GRU based on the deviation between the first predicted payment transaction and the second payment transaction. Transaction service provider system 104 may repeat determination of the first predicted transaction aggregate vector until transaction service provider system 104 determines that the deviation between the first predicted payment transaction and the second payment transaction satisfies an error threshold (e.g., is less than a predetermined value associated with an erroneous prediction of an expected payment transaction).

In some non-limiting embodiments, transaction service provider system 104 may determine a plurality of predicted transaction aggregate vectors associated with a plurality of predicted payment transactions based on the plurality of embedding payment transaction vectors associated with the plurality of payment transactions. For example, transaction service provider system 104 may determine a plurality of predicted transaction aggregate vectors associated with a plurality of predicted payment transactions for later use to determine whether one or more instant transactions are fraudulent or not fraudulent. In such an example, transaction service provider system 104 may store the predicted transaction aggregate vectors associated with the predicted payment transactions in a database. In another example, transaction service provider system 104 may store the predicted transaction aggregate vectors associated with the predicted payment transactions in a database, the predicted payment transactions associated with one or more account identifiers (e.g., PANs), respectively. For example, transaction service provider system 104 may store the predicted transaction aggregate vectors associated with the plurality of payment transactions in association with a corresponding account identifier in the database. Transaction service provider system 104 may then compare an instant transaction to one or more of the predicted transactions from among the plurality of payment transactions associated with the predicted transaction aggregate vectors stored in the database to determine whether a transaction is or is not fraudulent.

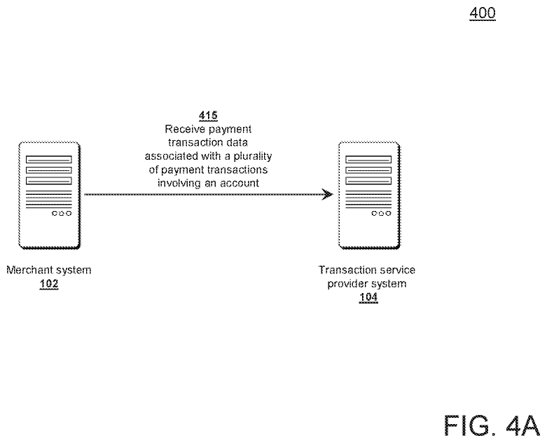

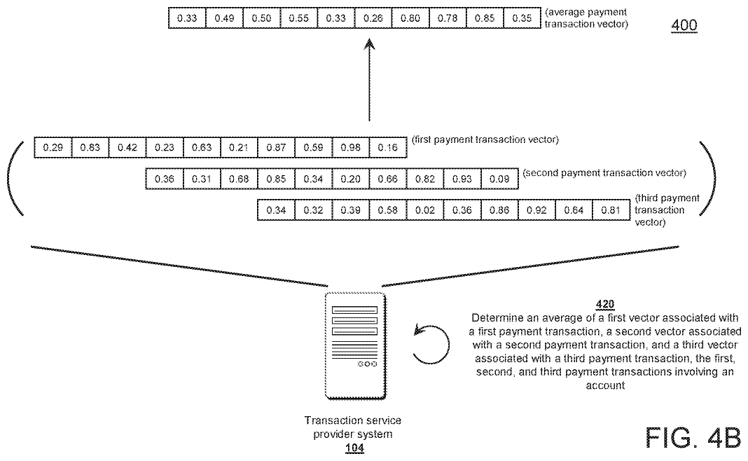

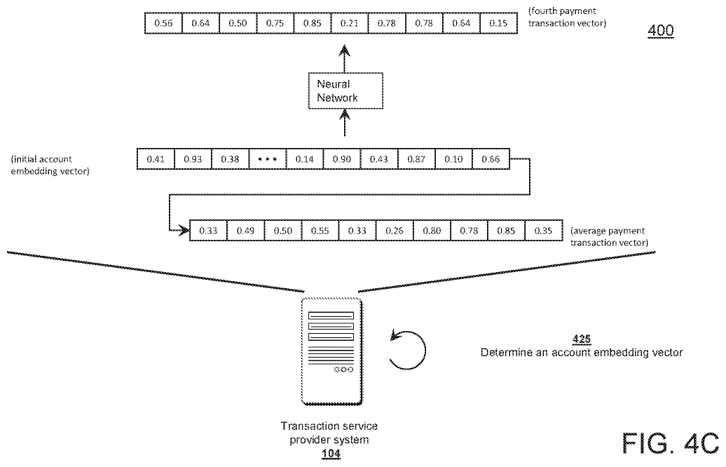

Referring now to FIGS. 4A-4C, illustrated is a non-limiting embodiment of an implementation 400 of a process for determining an account embedding vector. As shown by reference number 415 in FIG. 4A, transaction service provider system 104 may receive payment transaction data associated with a plurality of payment transactions involving an account (e.g., an account of a user associated with user device 110) from merchant system 102.

As shown by reference number 420 in FIG. 4B, transaction service provider system 104 may determine an average of a first payment transaction vector associated with a first payment transaction, a second payment transaction vector associated with a second payment transaction, and a third payment transaction vector associated with a third payment transaction. For example, transaction service provider system 104 may generate an average payment transaction vector based on values of the first payment transaction vector associated with the first payment transaction, values of the second payment transaction vector associated with the second payment transaction, and values of the third payment transaction vector associated with the third payment transaction. As shown in FIG. 4B, the first payment transaction vector, the second payment transaction vector, the third payment transaction vector, and the average payment transaction vector have 10 dimensions.

As shown by reference number 425 in FIG. 4C, transaction service provider system 104 may determine an account embedding vector associated with the account. For example, transaction service provider system 104 may initialize an array of values of the account embedding vector and transaction service provider system 104 may concatenate the initial account embedding vector with the average payment transaction vector to generate a first concatenated embedding transaction vector. In some non-limiting embodiments, the account embedding vector may have a number of dimensions that is greater than the number of dimensions of the average payment transaction vector. For example, the account embedding vector may have 100 dimensions and the average payment transaction vector may have 10 dimensions. In the example above, the first concatenated embedding transaction vector may be provided as an input to a neural network and the neural network may be trained to provide an output that corresponds to a fourth payment transaction vector. A modified embedding vector (e.g., an updated embedding vector) associated with the account may be obtained from the neural network based on training the neural network to provide an output that corresponds to the fourth payment transaction vector. For example, the modified embedding vector may include a weight matrix associated with a hidden layer of the neural network after the neural network is trained.

In some non-limiting embodiments, transaction service provider system 104 may concatenate the modified account embedding vector with the average payment transaction vector to generate a second concatenated embedding transaction vector. The second concatenated embedding transaction vector may be provided as an input to a neural network and the neural network may be trained to provide an output that corresponds to the fourth payment transaction vector. A further modified embedding vector (e.g., a final embedding vector) associated with the account may be obtained from the neural network based on training the neural network to provide an output that corresponds to the fourth payment transaction vector. For example, the further modified embedding vector may include a weight matrix associated with a hidden layer of the neural network after the neural network is trained. In such an example, the further modified embedding vector may equal the account embedding vector associated with the account.

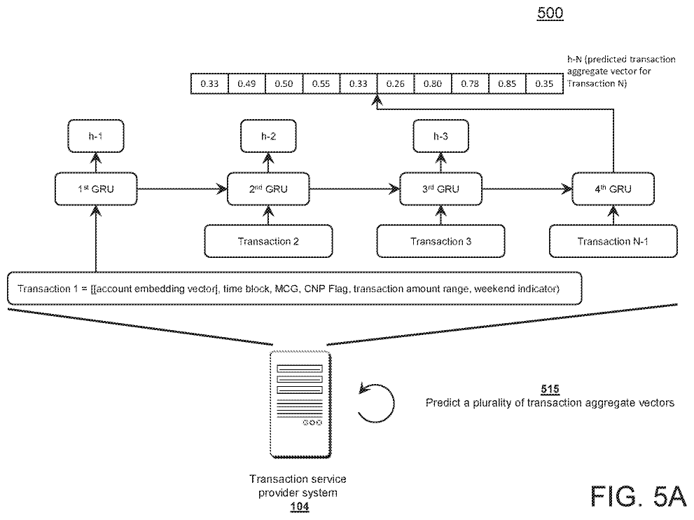

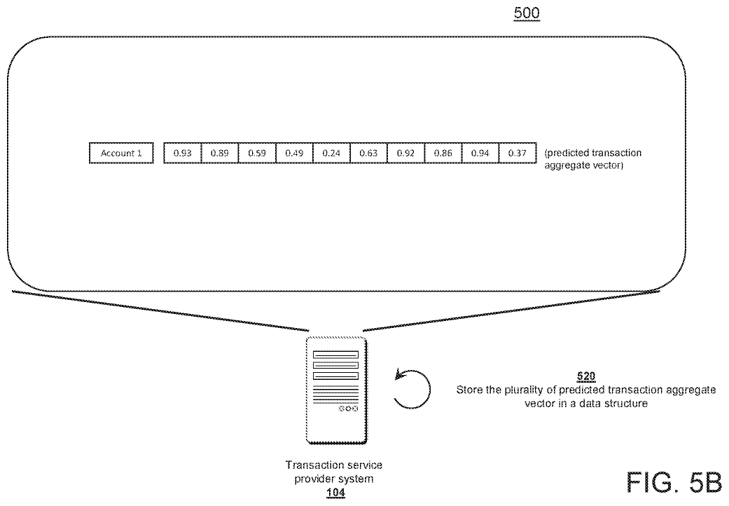

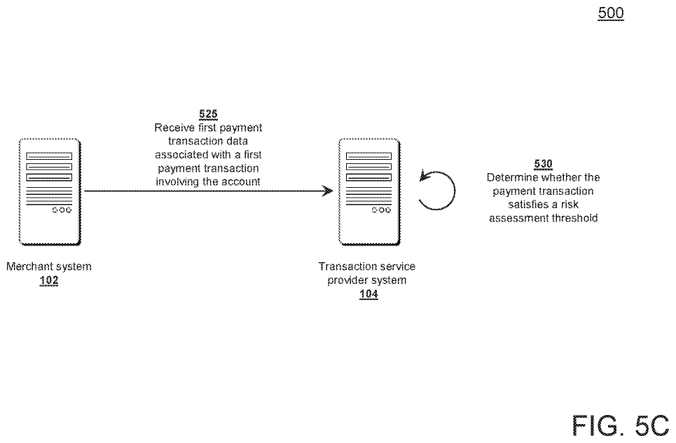

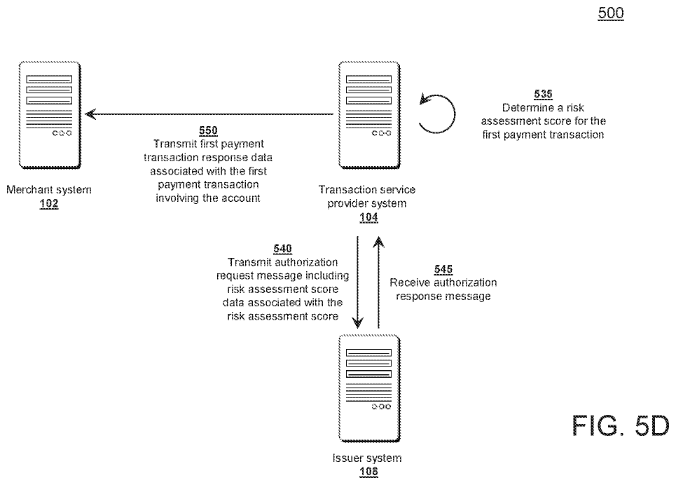

Referring now to FIGS. 5A-5D, illustrated is a non-limiting embodiment of an implementation 500 of a process for determining a predicted transaction aggregate vector. As illustrated in FIG. 5A, implementation 500 includes merchant system 102, transaction service provider system 104, and issuer system 108.

As shown by reference number 515 in FIG. 5A, transaction service provider system 104 may predict a plurality of predicted transaction aggregate vectors. For example, transaction service provider system 104 may provide as input to a machine learning model (e.g., a recurrent neural network including one or more gated recurrent units, a recurrent neural network including one or more long short-term memory cells, and/or the like) an account embedding vector associated with the account concatenated with a first embedding payment transaction vector associated with a first payment transaction. Transaction service provider system 104 may then receive as an output from the machine learning model a predicted transaction aggregate vector associated with the predicted future payment transaction associated with an account. Transaction service provider system 104 may predict a plurality of predicted transaction aggregate vectors by concatenating the account embedding vector associated with the account with each of the embedding payment transaction vectors associated with each of the payment transactions and providing, as input to the machine learning model, the concatenated vectors. Transaction service provider system 104 may then receive as an output from the machine learning model, a plurality of predicted transaction aggregate vectors associated with the account.

As shown by reference number 520 in FIG. 5B, transaction service provider system 104 may store the plurality of predicted transaction aggregate vectors received as output from the machine learning model in a data structure. For example, after transaction service provider system 104 receives as the output from the machine learning model one or more predicted transaction aggregate vectors associated with the account, transaction service provider system 104 may store the plurality of predicted transaction aggregate vectors in a data structure (e.g., in a data structure maintained in a database included in and/or in communication with transaction service provider system 104). In such an example, transaction service provider system 104 may store the plurality of predicted transaction aggregate vectors in association with data associated with an account identifier in the data structure.

As shown by reference number 525 in FIG. 5C, transaction service provider system 104 may receive first payment transaction data associated with a first payment transaction from merchant system 102. In some non-limiting embodiments, the first payment transaction may include transaction data associated with a transaction involving merchant system 102 and user device 110 (FIG. 1).

As shown by reference number 530 in FIG. 5C, transaction service provider system 104 may determine whether the first payment transaction associated with the first payment transaction data satisfies a risk assessment threshold for a machine learning model. For example, transaction service provider system 104 may determine whether one or more values associated with one or more parameters of the first payment transaction satisfy the risk assessment threshold. Where the one or more values associated with one or more parameters of the first payment transaction satisfy the risk assessment threshold, transaction service provider system 104 may determine a risk assessment score for the first payment transaction to be included in data associated with an authorization request message. Additionally, or alternatively, where the one or more values associated with one or more parameters of the first payment transaction does not satisfy the risk assessment threshold, transaction service provider system 104 may forego determining the risk assessment score for the first payment transaction.

As shown by reference number 535 in FIG. 5D, transaction service provider system 104 may determine a risk assessment score for the first payment transaction. For example, transaction service provider system 104 may determine the risk assessment score for the first payment transaction based on comparing a first payment transaction vector associated with the first payment transaction (e.g., a first payment transaction vector associated with the first payment transaction generated by transaction service provider system 104 based on the first payment transaction data associated with the first payment transaction) to one or more of the plurality of transaction aggregate vectors stored in the data structure.

As shown by reference number 540 in FIG. 5D, transaction service provider system 104 may transmit an authorization request message to issuer system 108. For example, transaction service provider system 104 may transmit an authorization request message to issuer system 108, the authorization request message including risk assessment score data associated with the risk assessment score and/or the first payment transaction data associated with the first payment transaction.

As shown by reference number 545 in FIG. 5D, transaction service provider system 104 may receive an authorization response message from issuer system 108 including an indication as to whether the first payment transaction is approved or not approved.

As shown by reference number 550 in FIG. 5D, transaction service provider system 104 may transmit first payment transaction response data associated with the first payment transaction to merchant system 102. For example, transaction service provider system 104 may transmit first payment transaction response data associated with the first payment transaction, the first payment transaction response data including an indication as to whether the transaction is approved or not approved.

Although the above methods, systems, and computer program products have been described in detail for the purpose of illustration based on what is currently considered to be the most practical and preferred embodiments or aspects, it is to be understood that such detail is solely for that purpose and that the present disclosure is not limited to the described embodiments or aspects but, on the contrary, is intended to cover modifications and equivalent arrangements that are within the spirit and scope of the appended claims. For example, it is to be understood that the present disclosure contemplates that, to the extent possible, one or more features of any embodiment or aspect can be combined with one or more features of any other embodiment or aspect.

What is claimed is:

1. A computer-implemented method, comprising:
receiving, with at least one processor, payment transaction data associated with a plurality of payment transactions involving an account;
determining, with at least one processor, an average payment transaction vector associated with an average of a first payment transaction vector associated with a first payment transaction involving the account and a second payment transaction vector associated with a second payment transaction involving the account;
determining, with at least one processor, an account embedding vector associated with the account;
determining, with at least one processor, a predicted transaction aggregate vector associated with the account based on the account embedding vector and a plurality of embedding payment transaction vectors associated with a plurality of payment transactions, wherein determining the predicted transaction aggregate vector comprises:
providing the account embedding vector and a first embedding payment transaction vector associated with a first payment transaction as an input to a first gated recurrent unit (GRU),
providing an output of the first GRU to a second GRU and a second embedding payment transaction vector associated with a second payment transaction, wherein the output of the first GRU comprises a first set of weights, and
obtaining an output from the second GRU comprising the predicted transaction aggregate vector associated with the account; and
storing, with at least one processor, the predicted transaction aggregate vector associated with a predicted payment transaction in a data structure based on an account identifier of the account.

2. The method of claim 1, further comprising:
receiving first payment transaction data associated with a first payment transaction involving the account, the first payment transaction being conducted in real-time;
determining whether the first payment transaction satisfies a risk assessment threshold based on the first payment transaction data associated with the first payment transaction involving the account; and
determining whether a predicted transaction aggregate vector associated with the account is stored in the data structure.

3. The method of claim 2, further comprising:
retrieving the predicted transaction aggregate vector associated with the account based on determining that the predicted transaction aggregate vector associated with the account is stored in the data structure.

4. The method of claim 3, further comprising:
determining a risk assessment score for the first payment transaction based on the predicted transaction aggregate vector associated with the account and the first payment transaction data associated with the first payment transaction involving the account; and
performing an action based on determining that the risk assessment score satisfies a threshold.

5. The method of claim 2, further comprising:
generating the predicted transaction aggregate vector associated with the account based on determining that the predicted transaction aggregate vector associated with the account is not stored in the data structure.

6. The method of claim 1, wherein the first payment transaction vector associated with the first payment transaction comprises a plurality of values, the plurality of values associated with a merchant category group of the first payment transaction, a transaction amount of the first payment transaction, and a merchant location of a merchant involved in the first payment transaction,
wherein the second payment transaction vector associated with the second payment transaction comprises a plurality of values, the plurality of values associated with a merchant category group of the second payment transaction, a transaction amount of the second payment transaction, and a merchant location of a merchant involved in the second payment transaction; and
wherein determining the average of the first payment transaction vector associated with the first payment transaction and the second payment transaction vector associated with the second payment transaction comprises:
determining an average of the plurality of values associated with the merchant category group of the first payment transaction, the transaction amount of the first payment transaction, the merchant location of the merchant involved in the first payment transaction and the plurality of values associated with the merchant category group of the second payment transaction, the transaction amount of the second payment transaction, the merchant location of a merchant involved in the second payment transaction to generate an average transaction vector.

7. The method of claim 6, wherein determining the account embedding vector associated with the account comprises:
concatenating the average transaction vector and an initial account embedding vector to generate a concatenated embedding payment transaction vector associated with the account; and
providing the concatenated embedding payment transaction vector as an input to a neural network.

8. The method of claim 7, wherein determining the account embedding vector associated with the account comprises:
determining a plurality of values of the account embedding vector associated with the account such that an output of the neural network is equal to a third payment transaction vector associated with a third payment transaction involving the account.

9. A system, comprising:
at least one processor programmed or configured to:
determine an average payment transaction vector based on a first payment transaction vector associated with a first payment transaction involving an account and a second payment transaction vector associated with a second payment transaction involving the account;
determine an account embedding vector associated with the account based on the first payment transaction vector associated with the first payment transaction and the second payment transaction vector associated with the second payment transaction;
determine a predicted transaction aggregate vector associated with the account based on the account embedding vector and a plurality of embedding payment transaction vectors associated with a plurality of payment transactions; and
store the predicted transaction aggregate vector in a data structure based on an account identifier of the account.

10. The system of claim 9, wherein, when determining the predicted transaction aggregate vector, the at least one processor is programmed or configured to:
provide the account embedding vector and a first embedding payment transaction vector associated with a first payment transaction as an input to a first gated recurrent unit (GRU); and
provide a plurality of weight values from the first GRU, the account embedding vector, and a second embedding payment transaction vector associated with a second payment transaction as an input to a second GRU;
wherein an output of the second GRU comprises the predicted transaction aggregate vector.

11. The system of claim 9, wherein the at least one processor is further programmed or configured to:
receive first payment transaction data associated with a first payment transaction involving the account, the first payment transaction being conducted in real-time;
determine whether a predicted transaction aggregate vector associated with the account is stored in the data structure.

12. The system of claim 11, wherein the at least one processor is further programmed or configured to:
retrieve the predicted transaction aggregate vector associated with the account based on determining that the predicted transaction aggregate vector associated with the account is stored in the data structure.

13. The system of claim 12, wherein the at least one processor is further programmed or configured to:
determine a risk assessment score for the first payment transaction based on the predicted transaction aggregate vector associated with the account and the first payment transaction data associated with the first payment transaction involving the account;
determining whether the risk assessment score for the first payment transaction satisfies a risk assessment threshold; and
perform an action based on determining that the risk assessment score for the first payment transaction satisfies a risk assessment threshold.

14. The system of claim 11, wherein the at least one processor is further programmed or configured to:
generate the predicted transaction aggregate vector associated with the account based on determining that the predicted transaction aggregate vector associated with the account is not stored in the data structure.

15. A computer program product comprising at least one non-transitory computer-readable medium comprising one or more instructions that, when executed by at least one processor, cause the at least one processor to:
receive payment transaction data associated with a plurality of payment transactions;
determine an average of a first payment transaction vector associated with a first payment transaction and a second payment transaction vector associated with a second payment transaction based on the payment transaction data associated with the plurality of payment transactions;
determine an account embedding vector associated with an account based on the average of the first payment transaction vector associated with the first payment transaction and the second payment transaction vector associated with the second payment transaction;
determine a predicted transaction aggregate vector associated with the account based on the account embedding vector and a plurality of embedding payment transaction vectors associated with a plurality of payment transactions, wherein, when determining the predicted transaction aggregate vector, the one or more instructions that, when executed by the at least one processor, cause the at least one processor to:
provide the account embedding vector and a first embedding payment transaction vector associated with a first payment transaction as an input to a first gated recurrent unit (GRU),
provide a plurality of weight values from the first GRU, the account embedding vector, and a second embedding payment transaction vector associated with a first payment transaction as an input to a second GRU, and
obtain an output from the second GRU, wherein the output comprises the predicted transaction aggregate vector; and
store the predicted transaction aggregate vector in a data structure based on an account identifier of the account.

16. The computer program product of claim 15, wherein the first payment transaction vector associated with the first payment transaction comprises a plurality of vector values associated with a merchant category group of the first payment transaction, a transaction amount of the first payment transaction, and a merchant location of a merchant involved in the first payment transaction and wherein the second payment transaction vector associated with the second payment transaction comprises a plurality of vector values associated with a merchant category group of the second payment transaction, a transaction amount of the second payment transaction, and a merchant location of a merchant involved in the second payment transaction; and
wherein the one or more instructions that cause the at least one processor to determine the average of the first payment transaction vector associated with the first payment transaction and the second payment transaction vector associated with the second payment transaction cause the at least one processor to:
determine an average of the plurality of vector values associated with the merchant category group of the first payment transaction, the transaction amount of the first payment transaction, the merchant location of the merchant involved in the first payment transaction and the plurality of vector values associated with the merchant category group of the second payment transaction, the transaction amount of the second payment transaction, the merchant location of a merchant involved in the second payment transaction to generate an average transaction vector.

17. The computer program product of claim 16, wherein the one or more instructions that cause the at least one processor to determine the account embedding vector associated with the account cause the at least one processor to:
concatenate the average transaction vector and the account embedding vector associated with the account to generate a concatenated embedding payment transaction vector; and
provide the concatenated embedding payment transaction vector as an input to a neural network.

18. The computer program product of claim 17, wherein the one or more instructions that cause the at least one processor to determine the account embedding vector associated with the account cause the at least one processor to:
determine a plurality of vector values of the account embedding vector associated with the account such that an output of the neural network is equal to a third vector associated with a third payment transaction involving the account.

19. The computer program product of claim 15, wherein the one or more instructions further cause the at least one processor to:
receive first payment transaction data associated with a first payment transaction involving the account, the first payment transaction being conducted in real-time;
determine whether the payment transaction satisfies a risk assessment threshold based on the payment transaction data associated with the payment transaction involving the account; and
determine whether a predicted transaction aggregate vector associated with the account is stored in the data structure.

20. The computer program product of claim 19, wherein the one or more instructions further cause the at least one processor to:
retrieve the predicted transaction aggregate vector associated with the account based on determining that the predicted transaction aggregate vector associated with the account is stored in the data structure.
